(19) United States
(12) Patent Application Publication
(10) Pub. No.: US 2026/0087502 A1
(43) Pub. Date: Mar. 26, 2026

(54) METHOD AND APPARATUS FOR PROVIDING EDUCATIONAL HISTORY INFORMATION PLATFORM SERVICE THROUGH NEURAL CONSENSUS PROOF USING BLOCKCHAIN NETWORK BASED ON RANDOM CONSENSUS PROOF

(71) Applicant: LEADPOINT SYSTEM INC., Jeonju (KR)

(72) Inventors: Eun Ju BAEK, Namyangju (KR); Do Hyoung Kim, Namyangju (KR)

(21) Appl. No.: 18/936,803

(22) Filed: Nov. 4, 2024

(30) Foreign Application Priority Data
Sep. 26, 2024 (KR) 10-2024-0130775

(51) Int. Cl. G06Q 30/018

(52) U.S. Cl. CPC G06Q 30/018; G06Q 2220/00

(57) ABSTRACT

Proposed are a method and an apparatus thereof for providing an educational history information platform service through neural consensus proof using a blockchain network based on random consensus proof, the method including registering resume ledger data corresponding to a first user on a ledger information database organized on the basis of user information, verifying at least one of educational history information, career information, and portfolio information, obtained in response to the resume ledger data, combining verification information generated according to the verification processing and the educational history information, career information, and portfolio information to organize history block data, propagate the history block data to a neural consensus proof-based blockchain network, and establish a connection to a new block shared through the blockchain network, and registering the history block data propagated to the blockchain network in the ledger information database by mapping the history block data to the resume ledger data.

### CROSS REFERENCE TO RELATED APPLICATION

The present application claims priority to Korean Patent Application No. 10-2024-0130775, filed September 26, 2024, the entire contents of which are incorporated herein for all purposes by this reference.

### BACKGROUND OF THE INVENTION

### FIELD OF THE INVENTION

The present disclosure relates to a service provision method and an apparatus thereof. More particularly, the present disclosure relates to a method and an apparatus thereof for providing an educational history information platform service through a neural consensus proof using a random consensus proof-based blockchain network.

### DESCRIPTION OF THE RELATED ART

In general, a blockchain, which is one type of distributed database, uses a peer-to-peer (P2P) network. A distributed database is a technology that makes many users share a large-scale database by physically distributing data. A blockchain is a structure list and network participant node devices can store data and collectively record and manage master data recording transaction information through verification.

As an example using a blockchain, a blockchain may be formed when node devices of virtual currency users connected through the internet constitute a P2P network. Accordingly, a block having a transaction history of virtual currencies can be managed at user node devices, can be connected with a new block, and can be propagated. When a new block is created, a block verified through a consensus algorithm of many participants (node devices) can be connected with an existing block, and can be confirmed as a final ledger including a transaction history and can be distributed and stored. Further, when a transaction occurs at a participant node device, transaction information verified through validation of the transaction is propagated to every node device. Accordingly, the transaction history, that is, the verified transaction is propagated and distributionally stored, and when some nodes forge data, it is possible to ascertain the truth of the data on the basis of the distributionally stored transaction. The more the users who share data, the more the security stability of a blockchain increases. Blockchains are used in various online services such as a cloud computing service in addition to Bitcoin.

Blockchain technology may reduce transaction costs and prevent data falsification by changing the existing centralized data management structures to decentralized or distributed structures. Economic value may be created by using such blockchain technology in combination with the public sector and with industries in the fields of finance, healthcare, content, logistics, distribution, energy, etc.

Specifically, in a case of providing information such as resumes through blockchain data in recruitment services and the like, career information becomes verifiable and permanently preserved, so there is an advantageous aspect therefor.

However, the resume and recruitment-related blockchain technology proposed so far utilizes blockchain networks already built by using existing PoW and PoS mining methods such as Bitcoin, so there are problems in that computer processing power is wasted and specific limitations exist in this technology.

Furthermore, history information for recruitment requires separate verification in addition to preventing falsification, but currently existing blockchain systems are unable to properly verify the history information of job seekers and merely store the history information permanently, so there is still a problem of having to go through the verification by separate external agencies as before.

### SUMMARY OF THE INVENTION

The present disclosure is for solving the above-mentioned problems, and an objective of the present disclosure is to provide a service provision apparatus and a method thereof, which are configured to enable accurate history management without requiring verification by separate external agencies, as the verification and block formation processing are performed within a blockchain network when user history information is registered, thereby facilitating the operation of a prospective employee recruitment platform service.

In addition, in configuring a blockchain network for the operation of platform services, another objective of the present disclosure is to provide a service provision apparatus and an operation method therefor capable of creating a neural consensus proof module cluster that utilizes an existing non-random consensus proof-based blockchain network as a random consensus proof-based blockchain network, so that support is provided to operate the random consensus proof-based blockchain network, which is based on the previously built existing blockchain network, while controlling that the blockchain network previously built in a PoW or PoS method will no longer operate in the PoW or PoS method, thereby overcoming the problems and limitations of the PoW and PoS methods.

According to an exemplary embodiment of the present disclosure for solving the above-mentioned problems, there is provided a method including: registering resume ledger data corresponding to a first user on a ledger information database organized on the basis of user information; performing verification processing on at least one of educational history information, career information, and portfolio information, which are obtained in response to the resume ledger data; combining verification information generated according to the verification processing and the educational history information, career information, and portfolio information, so as to organize history block data, propagate the history block data to a neural consensus proof-based blockchain network, and establish a connection to a new block shared through the blockchain network; registering the history block data propagated to the blockchain network in the ledger information database by mapping the history block data to the resume ledger data; and performing a company matching service process using the resume ledger data to which the history block data is mapped according to the performing of the history information platform service, wherein the neural consensus proof-based blockchain network may include a non-random consensus proof-based blockchain network and a node device constituting a neural consensus proof module cluster.

Meanwhile, the method according to the exemplary embodiments of the present disclosure as described above may be implemented with a program for executing the method on a computer and a computer-readable recording medium having the program recorded thereon.

According to the exemplary embodiments of the present disclosure, there may be provided the service provision apparatus and the operation method thereof, wherein verification processing is performed on at least one of the educational history information, career information, and portfolio information that are obtained in response to the resume ledger data of the ledger information database organized on the basis of user information, history block data is organized by combining verification information and the above educational history information, career information, and portfolio information, and the history block data is propagated to a neural consensus proof-based blockchain network, so that the processes of history information platform service and company matching service may be provided by using the history block data, whereby accurate history management is enabled without requiring the verification by the separate external agencies, and accordingly the operation of prospective employee recruitment platform services may be facilitated.

Furthermore, the blockchain network utilized for such verification and platform services may be built through a creation process based on a neural consensus proof, so this blockchain network may be converted and used as the random consensus proof-based blockchain network while maintaining the infrastructure and usability of the existing non-random consensus proof-based blockchain network as much as possible, whereby not only an efficient and fair distributed consensus process based on a neural consensus proof may be provided while preventing waste of resources and social costs, but also it is possible to enable the smoothly and long-term operation of the prospective employee recruitment platform service of the present disclosure requiring self-verification and preservation of permanent history information.

### BRIEF DESCRIPTION OF THE DRAWINGS

The above and other objectives, features and other advantages of the present disclosure will be more clearly understood from the following detailed description when taken in conjunction with the accompanying drawings.

FIG. 1 is a diagram schematically showing an entire system according to an embodiment of the present disclosure.

FIG. 2 is a diagram for explaining a blockchain network according to an embodiment of the present disclosure.

FIG. 3 is a block diagram more specifically illustrating a service provision apparatus according to an exemplary embodiment of the present disclosure.

FIGS. 4 and 5 are flowcharts illustrating operations of the service provision apparatus according to the exemplary embodiments of the present disclosure.

FIG. 6 is a view illustrating a recruitment platform service structure according to the exemplary embodiments of the present disclosure.

FIG. 7 is a flowchart illustrating an operation of a service provision apparatus according to another exemplary embodiment of the present disclosure.

FIG. 8 is a block diagram showing in more detail a node device according to an embodiment of the present disclosure;

FIG. 9 is a conceptual diagram for explaining the configuration of a neural consensus proof module cluster according to an embodiment of the present disclosure and the entire process.

FIG. 10 is a flowchart for explaining a method of operating the node device according to an embodiment of the present disclosure.

FIGS. 11 to 14 are views exemplifying data by step that are processed by a consensus proof module node device according to an embodiment of the present disclosure;

FIG. 15 is a flowchart for explaining a method of operating a node device according to another embodiment of the present disclosure;

FIG. 16 is a flowchart for explaining a method of operating a node device device according to another embodiment of the present disclosure;

FIG. 17 is a block diagram illustrating the hardware configuration of a computing device used to implement various embodiments of the present disclosure.

### DETAILED DESCRIPTION OF THE INVENTION

The following provides only the principle of the present disclosure. Accordingly, those skilled in the art may implement the principle of the present disclosure and various apparatuses included in the concept and range of the present disclosure which are not clearly described or shown herein though. All conditional terminologies and embodiments described herein should be understood as being definitely intended as an object for understanding the concept of the present disclosure without limiting the specifically stated embodiments and states.

Further, all detailed descriptions enumerate not only the principle, aspects, and embodiments of the present disclosure, but specific embodiments should be understood as being intended to include structural and functional equivalents of those matters. Further, these equivalents should be understood as including all elements designed to perform the same functions regardless of not only equivalents known at present, but equivalents, that is, structures to be developed in the future.

Accordingly, for example, block diagrams of this specification should be understood as showing an exemplary conceptual respect that concretes the principle of the present disclosure. Similarly, all of flowcharts, state conversion diagrams, intention codes, etc. should be understood as showing various processes that can be substantially shown on computer-readable media and are performed by computers and processors regardless of whether a computer or a processor is definitely shown.

Further, definite use of terms proposed as a processor, control, or similar concepts should not be construed by exclusively citing hardware having ability to execute software and should be construed as suggestively including digital signal processor (DSP) hardware, and a ROM, a RAM, and a nonvolatile memory for storing software without limitation. Other well-known and generally used hardware may also be included.

The objectives, features, and advantages of the present disclosure described above will be clearer through the following detailed description relating to the accompanying drawing, so the spirit of the present disclosure would be easily implemented by those skilled in the art. Further, in description of the present disclosure, well-known technologies are not described in detail not to unnecessarily obscure the subject of the present disclosure.

Hereinafter, exemplary embodiments of the present disclosure will be described in detail with reference to the accompanying drawings.

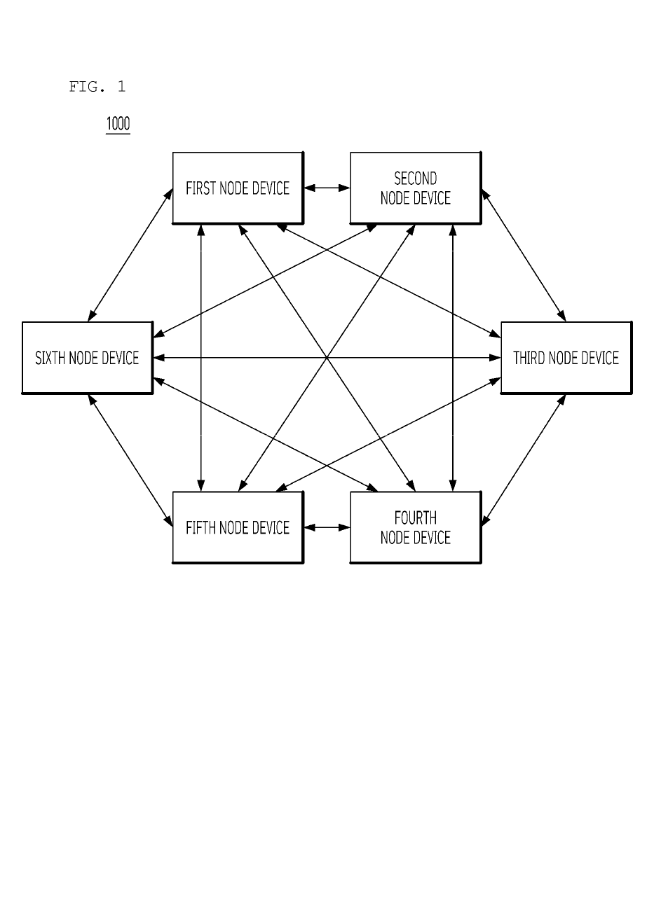

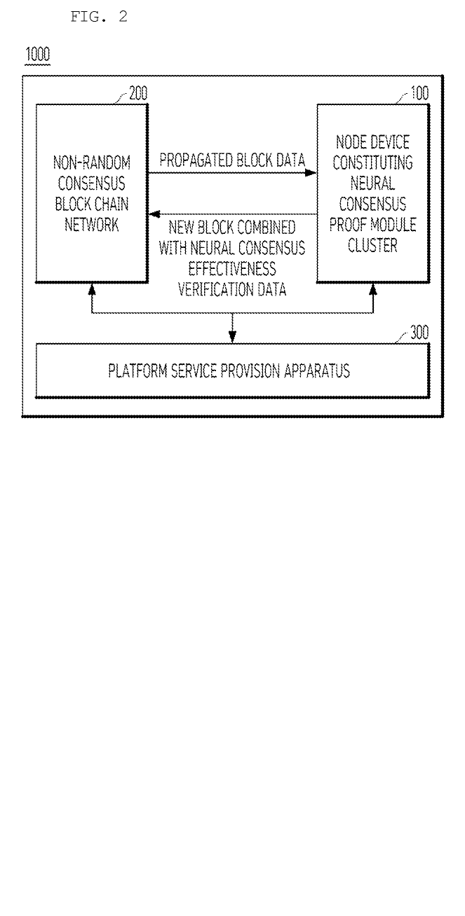

FIG. 1 is a diagram schematically showing an entire system according to an embodiment of the present disclosure and FIG. 2 is a diagram for explaining a blockchain network according to an embodiment of the present disclosure.

First, referring to FIG. 1, in a blockchain network system 1000 according to an embodiment of the present disclosure, a blockchain network of mesh-type network topology can be configured by one or more node devices connected through a wired or wireless network. The node devices are connected to the blockchain network through I/O devices and can exchange data. The blockchain network system 1000 may include, as the node devices, various electronic systems such as mobile devices including a mobile phone, a smartphone, a PDA, a tablet computer, a laptop, etc., computing devices including a personal computer, a tablet computer, a netbook, etc., or electronic products including a television, a smart television, a security device for gate control, etc.

Further, the node devices 100 each may have a communication module for connecting to the blockchain network. The blockchain network, for example, may be implemented as a wired network such as a Local Area Network (LAN), a Wide Area Network (WAN), or a Value Added Network (VAN). Further, the blockchain network may be implemented as all kinds of wireless networks such as a mobile radio communication network, a satellite communication network, Bluetooth, Wireless Broadband Internet (Wibro), High Speed Downlink Packet Access (HSDPA), Wi-Fi, Long Term Evolution (LTE). Depending on necessity, the blockchain network may be a wired-wireless mixed network.

Further, each of the node devices can register account information according to its node connection in transaction ledger data that are shared in a cloud manner through a network. Further, when there is a need for a transaction of encryption information for creating a blockchain, each trader terminal can propagate transaction information to be recorded in the transaction ledger data to every trader terminal.

Further, the transaction ledger data are updated and the information thereof is shared in accordance with mutual verification processing corresponding to the above process, whereby a transaction of encryption information for creating a blockchain can be made.

In this case, the transaction ledger data can be linked with a blockchain data having a structure in which a plurality of blocks is sequentially connected in order of creation by making each of blocks corresponding to predetermined times or units include a hash value for a block created before a current block. Accordingly, it is possible to easily verify whether the transaction ledger data have been tampered by verifying the hash values of the blockchain.

Security stability of the blockchain can be implemented by participation in the system of sharers who share data. Accordingly, transaction information blocks, which include specifications of sharing between sharer terminals connected to the blockchain network, specifications of issuance/transaction of encryption information for creating the blockchain, etc., can be sequentially stored, and transaction verification processing for sequentially making hash values for anti-tempering thereof into a blockchain can be distributionally performed at the trader terminals.

In such verification processing, as shown in FIG. 2, a pre-constructed blockchain network may be usually a non-random consensus proof-based blockchain network. Representatively, Proof-of-Work (PoW), Proof-of-Stake (PoS), etc. may be the non-random consensus proof-based blockchain network 200, and blockchain networks such as Bitcoin and Ethereum may correspond thereto.

More Specifically, a blockchain enables a node participating in a network to create a block and propagate created block information to other nodes. Further, the nodes receiving new block information can determine and verify consistency of the new block information. In this case, verifying effectiveness of a transaction history that may be included in the new created block, that is, a transaction may also be performed at the node participating in the network.

Further, a consensus algorithm may be applied to a blockchain network to secure integrity of block information constituting a ledger, which is managed by participant nodes, and examine validity of the block information. As the consensus algorithm, Proof of Work (PoW), Proof of Stake (PoS), Delegated Proof of Stake (DPoS), Practical Byzantine Fault Tolerance (PBFT), etc. are generally applied.

Proof-of-Work (PoW) is a method of suppressing illegality by proving that resources (e.g., computing power, etc.) have been input for work. Participant nodes have to necessarily input resources to participate in PoW. Spam, DoS attack, or the like also can succeed only when inputting 51% of more of resources.

PoW needs an eigen hash value to create a block and the eigen hash value is a value that has to be found out by randomly substituting nonce values, so resources such as computing power have to be excessively input to determine such an eigen hash value, costs and an environmental problem are caused by power consumption, and specific function-intensive chips are required, whereby a problem of centralization may be caused due to union of computing power.

In order to solve these problems, Proof-of-Stake (PoS) was proposed and PoS employs a method that can achieve proof in proportion to the holding stakes of nodes. PoS makes the possibility of being able to create a block be proportioned to the stake of tokens of each node. Assuming that the stake of tokens is a resource to be input in PoS, PoS can be considered as one detailed type of PoW. The algorithm formula of PoS can be expressed as ‘PoW using a digest’. PoS, in comparison to PoW, hardly consumes energy and makes resource intensiveness difficult.

However, since PoS is a manner that becomes more advantageous as the stake increases, a problem of block creation centralization may be generated due to a stake and nodes may show tendency to only collect tokens and not be reluctant to use the tokens. Further, since the stake reaches 100% at the point in time of a genesis block corresponding to the first block of a blockchain, the person who started the system can make all of the blocks again and again. Since each node also can start again from the point in time as long as it has a stake, tempering cannot be prevented only through PoS.

In order to solve this problem, a method for selecting a consensus node using nonce has been disclosed in Korean Patent Application Publication No. 10-2019-0122149. This manner uses a fair random consensus, so it is not required to use excessive resources like PoW and only some nodes, which are selected as a consensus in accordance with a nonce chain, of all nodes participate in block creation to be able to remove the defect that nodes having a lot of resources monopolize the update right like PoS, thereby having the advantage that consumption of resources is minimized, it is made impossible to guess nodes to obtain the right to create blocks through a nonce proof process and a predetermined number of or more consensus nodes are selected as a probable representative of all of nodes.

Nevertheless, blockchain networks already globally constructed at present such as Bitcoin or Ethereum still use PoW and Pos manners, and Private blockchain network, etc. operate a network in which only a small number of nodes can participate like PBFT to keep efficiency of the amount of communication. Accordingly, even though a new consensus technique is proposed and a new network is constructed, it is very difficult to quickly overcome a waste of resources and social costs caused by the already established extensive existing blockchain networks.

Accordingly, node device 100 according to an embodiment of the present disclosure can constitute a neural consensus proof module cluster, and the neural consensus proof module cluster can configure a new block combined with neural consensus validation data on the basis of random consensus proof manner and can process the configured new block to be propagated through the non-random consensus blockchain network 200.

Accordingly, in the non-random consensus blockchain network 200, the propagated block data are shared again in the network and can be processed such that a next block is created again by the node device 100 configuring the neural consensus proof module cluster. Since specific proof such as PoW and PoW is not required in this process, it is possible to construct a new random consensus blockchain network system 1000 that can implement decentralization in a non-competitive manner.

That is, according to an embodiment of the present disclosure, since the neural consensus proof module cluster that enables the existing non-random consensus proof-based blockchain network 200 to be used as the random consensus proof-based blockchain network 1000 is constructed using the node device 100, it is possible to provide the node device 100 forming a network that enables a random consensus proof-based blockchain network based on a pre-constructed blockchain network to be operated while controlling an existing pre-constructed PoW-type or PoS-type blockchain network not to be operated anymore in the PoW or PoS manner or to be limitatively operated in accordance with the minimum number of nodes of a Byzantine fault tolerance consensus.

Accordingly, it is possible to convert the pre-constructed non-random consensus proof-based blockchain network to be used as a random consensus proof-based blockchain network while maximally maintaining the infrastructure and usefulness of the pre-constructed non-random consensus proof-based blockchain network, so it is possible to provide a neural consensus proof-based distributed consensus process that prevents a waste of resources and social costs and is efficient and fair. In this case, a nonce chain and hash checking process configured on the basis of one-time random numbers may be used for participation qualification proof for a random consensus, but this is only an example designation and participation qualification proof of a random consensus can be possible even in various other manners.

Meanwhile, a platform service provision apparatus 300 may perform a process for providing a prospective employee recruitment platform service according to an exemplary embodiment of the present disclosure on the basis of a neural consensus proof-based blockchain network configured in this manner. To this end, the platform service provision apparatus 300 may be registered as one node device of a random consensus proof-based blockchain network 1000 configured on the basis of a neural consensus proof, and may provide the platform service using such a blockchain network.

The platform service provision apparatus 300 may receive requests from terminals using other general services not registered in the blockchain network and perform platform service processing that provides service information based on block data verified through the blockchain network.

More specifically, the platform service provision apparatus 300 performs a method thereof including: registering resume ledger data corresponding to a first user on a ledger information database organized on the basis of user information; performing verification processing on at least one of educational history information, career information, and portfolio information, which are obtained in response to the resume ledger data; combining verification information generated according to the verification processing and the educational history information, career information, and portfolio information, so as to organize history block data, propagate the history block data to a neural consensus proof-based blockchain network, and establish a connection to a new block shared through the blockchain network; registering the history block data propagated to the blockchain network in the ledger information database by mapping the history block data to the resume ledger data; and performing a company matching service process using the resume ledger data to which the history block data is mapped according to the performing of the history information platform service.

That is, the platform service provision apparatus 300 according to the exemplary embodiments of the present disclosure may generate and manage a user-specific resume ledger corresponding to each job seeker by using the neural consensus proof-based blockchain network, further process verification of internal educational history and portfolio, which are obtained through an education platform provided by the platform service provision apparatus 300, and provide verification services, prospective employee matching services, etc. in response to verification requests from recruiting companies and the like, as block data is generated by combining externally verified educational history, verification information, etc.

In addition, history information stored in a blockchain in this way may be determined on the block data through verification by other personal relationship terminals, so not only falsification is unattainable, but also the reliability of resume data itself may be ensured.

Furthermore, the platform service provision apparatus 300 may provide a decentralized platform service capable of providing blockchain network-based education recommendations, and education attendance and portfolio writing for proper matching of history information and company information, so that companies and job seekers, who have their various needs, may be connected to each other, thereby providing mutual trust therefor.

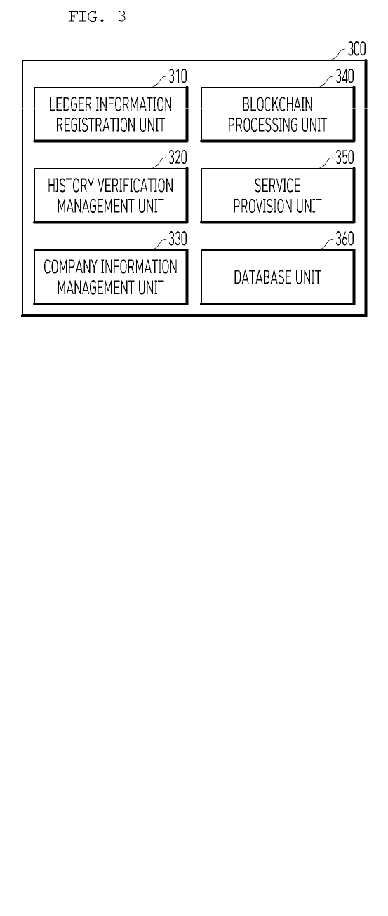

More specifically, FIG. 3 is a block diagram illustrating a platform service provision apparatus according to an exemplary embodiment of the present disclosure.

Referring to FIG. 3, the platform service provision apparatus 300 includes a ledger information registration unit 310, a history verification management unit 320, a company information management unit 330, a blockchain processing unit 340, a service provision unit 350, and a database unit 360.

The ledger information registration unit 310 registers resume ledger data corresponding to a first user in a ledger information database organized in the database unit 360 on the basis of user information. The resume ledger data may include, for example, personal information, educational history information, portfolio history information, career information, etc.

In addition, the history verification management unit 320 performs verification processing on at least one of the educational history information, career information, and portfolio information, which are obtained in response to the resume ledger data, generates verification information according to the verification processing, and transmits the verification information to the blockchain processing unit 340.

Accordingly, the blockchain processing unit 340 performs combining verification information generated according to the verification processing and the educational history information, career information, and portfolio information, so as to organize history block data, propagate the history block data to a neural consensus proof-based blockchain network, and establish a connection to a new block shared through the blockchain network.

Here, the history verification management unit 320 may perform various verification processes for verification processing of the resume ledger data, and verification information generated accordingly may be divided into first verification information according to internal verification and second verification information according to external verification.

First, in order to generate the first verification information, the history verification management unit 320 may receive first educational history information corresponding to a first user from an education platform service device connected through the neural consensus proof-based blockchain network, request internal platform verification corresponding to the first educational history information from one or more first personal relationship terminals connected through the neural consensus proof-based blockchain network, and generate the first verification information corresponding to the first educational history information by using response information from each first personal relationship terminal.

The first verification information as such may be obtained according to the education platform service provided through the platform service provision apparatus 300. Because of being able to check education attendance history, which is already provided through the neural consensus proof-based blockchain network and accordingly unable to be falsified, the platform service provision apparatus 300 may request internal platform verification corresponding to the first educational history information from the first personal relationship terminals of students, instructors, or the like, who have histories of having taken or taught the same education course, and generate the first verification information highly reliable according to information on response information confirmation.

In addition, in order to generate second verification information, the history verification management unit 320 may receive external history information or external career information, which is corresponding to the first user, from a user terminal that is separated from the neural consensus proof-based blockchain network, request verification of the external history information or external career information from one or more second personal relationship terminals corresponding to the external history information or external career information, and generate the second verification information corresponding to the external history information or external career information by using response information from each second personal relationship terminal.

Here, each second personal relationship terminal is a device for verifying external history information or external career information, and may correspond to a company colleague terminal or a separate institution terminal such as a verification server, so the second verification information may be less reliable than the first verification information. However, the history verification management unit 320 may combine the first verification information and the second verification information so as to organize verification information. The blockchain processing unit 340 may organize and propagate this verification information as blockchain data, thereby improving reliability and accuracy of the blockchain data.

Accordingly, the history block data may include the first verification information and the second verification information.

Accordingly, the service provision unit 350 may provide a platform service for identifying first resume ledger data matched with company information based on the history block data normally formed, and providing the first resume ledger data to one or more company terminals.

Here, when performing the company matching service process, the service provision unit 350 may provide compensation information to each personal relationship terminal used to generate the verification information of the history block data mapped with the first resume ledger data on the basis of the first resume ledger data that is provided to the company terminal. This is a way to increase the degree of participation in verification.

However, as described above, the reliability of the first verification information based on the neural consensus proof-based blockchain network may be higher than that of the second verification information of an external system, and there is a need to increase the degree of participation for system reliability, so it is preferable that a first compensation value for each first personal relationship terminal according to the first verification information is to be greater than a second compensation value for each second personal relationship terminal according to the second verification information. However, this is an implementation example, and may be determined differently or set identically depending on various preset verification information conditions.

Meanwhile, the service provision unit 350 may provide an education platform service for prospective employees, which are required by a company, according to a company matching service. Therefore, to this end, first, company information in a company terminal may be obtained through the company information management unit 330.

In addition, the service provision unit 350 may organize competency set information on the basis of the company information, and organize education course data, including project information and portfolio information, on the basis of the competency set information.

Accordingly, the service provision unit 350 may compare the education course data with the history block data of the first user to organize first education course information and first portfolio information, which are corresponding to the first user, and may use the first education course information and the first portfolio information to provide a first education service process to a user terminal of the first user.

In addition, the history verification management unit 320 may organize education completion verification information as the completion of providing the first education service process is confirmed and using the first portfolio information and education completion verification information to update the history block data of the first user.

The service provision unit 350 organizes prospective employee recommendation information using the resume ledger data corresponding to the updated history block data, and provides the prospective employee recommendation information to the company terminal, thereby providing the company matching platform service.

Meanwhile, the aforementioned neural consensus proof-based blockchain network may include: a non-random consensus proof-based blockchain network; and a node device 100 constituting a neural consensus proof module cluster. The blockchain processing unit 340 may propagate the history block data on the blockchain network by performing the function of the aforementioned node device 100.

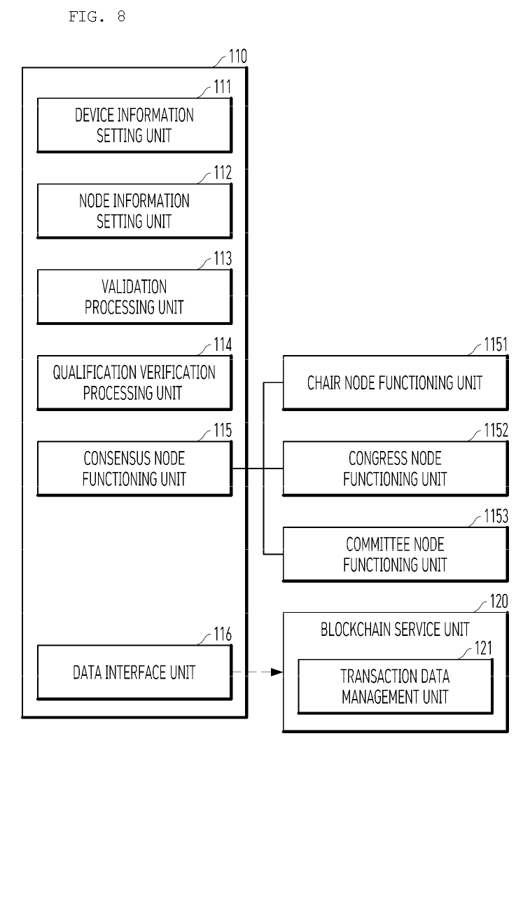

More specifically, the blockchain processing unit 340 obtains new block data propagated through the non-random consensus proof-based blockchain network and performs a neural consensus proof-based block generation process corresponding to the new block data according to preset conditions. The neural consensus proof-based block generation process may extract validation data from the new block data, obtain neural consensus designation information of a next block, which is generated on the basis of a random consensus proof process, according to the verification processing of the validation data, and generate the validation data of the next block by selectively operating a consensus node function unit on the basis of the neural consensus designation information of the next block, so the validation data may be organized to include consensus process verification data corresponding to the random consensus proof process. The specific details of such a processing process will be described in more detail with reference to FIGS. 8 to 16.

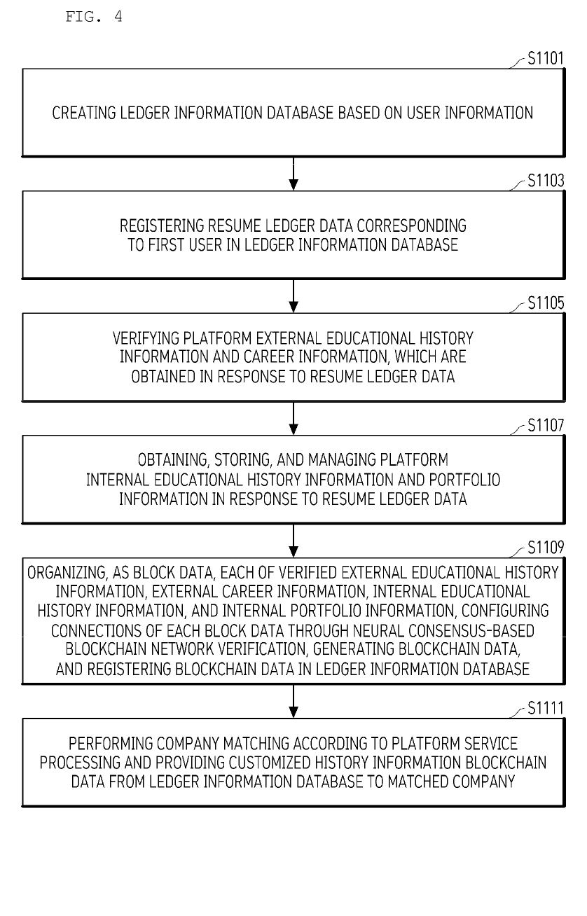

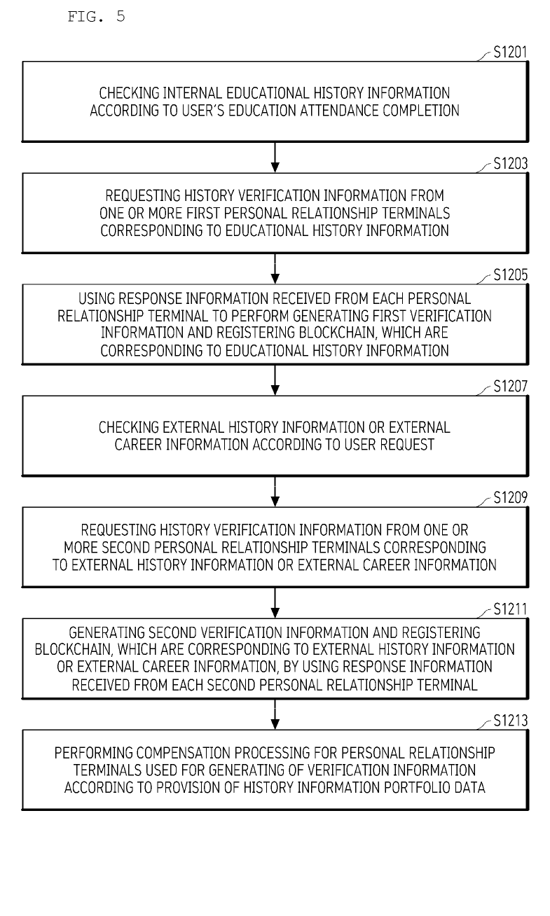

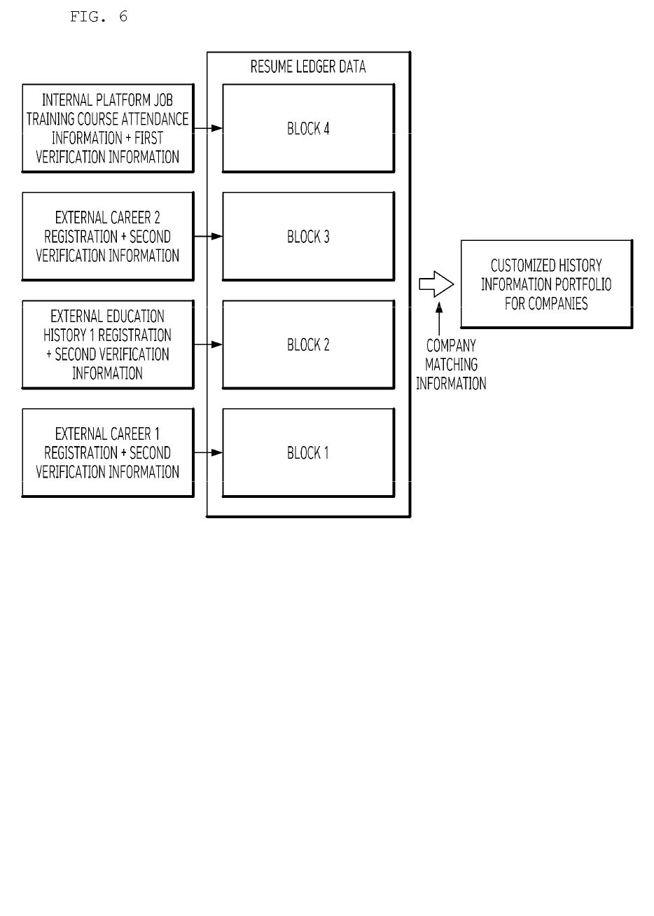

FIGS. 4 and 5 are flowcharts illustrating the operations of the service provision apparatus according to the exemplary embodiments of the present disclosure, and FIG. 6 is a view illustrating a recruitment platform service structure according to the exemplary embodiments of the present disclosure.

First, referring to FIG. 4, in step S1101, a platform service provision apparatus 300 creates a ledger information database based on user information.

In addition, in step S1103, the platform service provision apparatus 300 registers resume ledger data corresponding to a first user in the ledger information database.

Thereafter, in step S1105, the platform service provision apparatus 300 verifies platform external educational history information and career information, which are obtained in response to the resume ledger data.

Then, in step S1107, the platform service provision apparatus 300 obtains, stores, and manages platform internal educational history information and portfolio information in response to the resume ledger data.

Thereafter, in step S1109, the platform service provision apparatus 300 organizes, as block data, each of the verified external educational history information, external career information, internal educational history information, and internal portfolio information, configures connections of each block data through neural consensus-based blockchain network verification, generates blockchain data, and registers the blockchain data in the ledger information database.

Accordingly, in step S1111, the platform service provision apparatus 300 performs company matching according to platform service processing and provides customized history information blockchain data from the ledger information database to a matched company.

According to such a process, a user may register information on the attended internal educational history and portfolio as well as the attended external educational history and career, and receive the verified information through the platform service provision apparatus 300, thereby receiving resume ledger data generated for each history.

In addition, this resume ledger data may be mutually verified by dividing it into units of working period by the personal relationship terminals of colleagues, etc., and may be organized as blockchain data and stored and managed on the neural consensus proof-based blockchain network. Therefore, when a recruiting company requests resume verification, the resume ledger data may be first verified through block hash values and the like, and may be second verified through confirmation of internal verification information (e.g., confirmation of job training attendance, etc.) and external verification information. In addition, the verification information may also include personal information of the personal relationship terminals of people participated in the history verification, so the personal information of colleagues may be included as an example.

Accordingly, it is possible to prove portfolio and competency level through resume ledger management using the neural consensus proof-based blockchain, and this allows verification and management of job seekers’ resumes through a distributed resume management system shared by participants, and permanently preserves individual education histories, so records management becomes safe and self-verifiable in any situation.

Meanwhile, referring to FIGS. 5 and 6, the platform service provision apparatus 300 checks internal educational history information according to the user’s education attendance completion in step S1201, and requests history verification information from one or more first personal relationship terminals corresponding to the educational history information in step S1203.

Then, in step S1205, the platform service provision apparatus 300 uses response information received from each personal relationship terminal to perform generating first verification information and registering blockchain, which are corresponding to the educational history information.

Thereafter, the platform service provision apparatus 300 checks external history information or external career information according to a user request in step S1207, and requests history verification information from one or more second personal relationship terminals corresponding to the external history information or external career information in step S1209.

Then, the platform service provision apparatus 300 performs, in step S1211, generating second verification information and registering blockchain, which are corresponding to the external history information or external career information, by using response information received from each second personal relationship terminal, and performs, in step S1209, compensation processing for the personal relationship terminals used for the generating of the verification information according to the provision of history information portfolio data.

As described above, the platform service provision apparatus 300 may determine, for each unit of time, information about the educational history and portfolio taken within the internal education platform and the external history/career and portfolio through the verification by the personal relationship terminals of related colleagues, instructors, PMs, etc., store this information in a blockchain so as to make this information unable to be falsified, and secure the reliability of a resume in a job market by creating and providing the resume only with the history/career/portfolio stored in a block.

This improves the accuracy and success rate of matching by providing the matching service using reliable resumes.

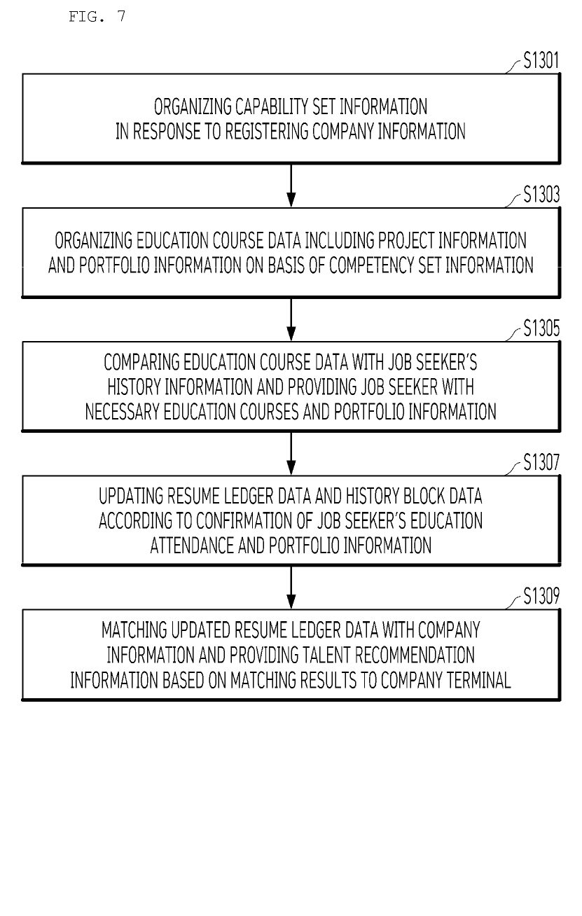

FIG. 7 is a flowchart illustrating an operation of a service provision apparatus according to another exemplary embodiment of the present disclosure.

Referring to FIG. 7, in step S1301, a platform service provision apparatus 300 organizes capability set information in response to registering company information.

Then, in step S1303, the platform service provision apparatus 300 organizes education course data including project information and portfolio information on the basis of the competency set information.

Thereafter, in step S1305, the platform service provision apparatus 300 compares the education course data with a job seeker’s history information and provides the job seeker with necessary education courses and portfolio information.

Then, in step S1307, the platform service provision apparatus 300 updates resume ledger data and history block data according to confirmation of the job seeker’s education attendance and portfolio information.

Thereafter, in step S1309, the platform service provision apparatus 300 matches the updated resume ledger data with company information and provides prospective employee recommendation information based on matching results to a company terminal.

In this way, the platform service may include a service for matching personal resumes and company demand, companies may request necessary prospective employee information and receive the prospective employee matching service, job seekers may receive a recommended company matching service or an education matching service for career management according to his or her career objective, and the platform may provide recommendation and matching services on the basis of the prospective employee demand of the companies and the job seekers’ resumes. In order to provide such services, an artificial intelligence learning-based matching model may be created and the artificial intelligence learning-based matching model can utilize known technologies such as CNN, DNN, RNN, and transformer models.

In accordance with the provision of such services, companies may register prospective employee information such as skill set information, competency set information, and career information in the platform service provision apparatus 300, and job seekers may take job training, participate in projects, and register external educational history, career information, and the like through the platform service provision apparatus 300.

In addition, since the platform service provision apparatus 300 is able to provide the matching service by analyzing company demand and individual resume ledger data, it may include a prospective employee matching service, a job matching service, an education matching service, and the like, and may further include a customized prospective employee search service for companies, an education search service, etc.

Accordingly, as described above, the platform service according to the exemplary embodiments of the present disclosure provides a reliable decentralized system for tracking people’s lifetime achievements and careers, and providing a way for recruiters to find ideal candidates required for organizations, and provides an environment for efficient cooperation between job seekers, recruiting companies, and headhunters, thereby tracking lifelong learning histories and careers, supporting recruiters to search for ideal candidates required for the organizations, ensuring the reliability of careers and resumes of individuals, and providing career and portfolio verification services for prospective employees required by companies.

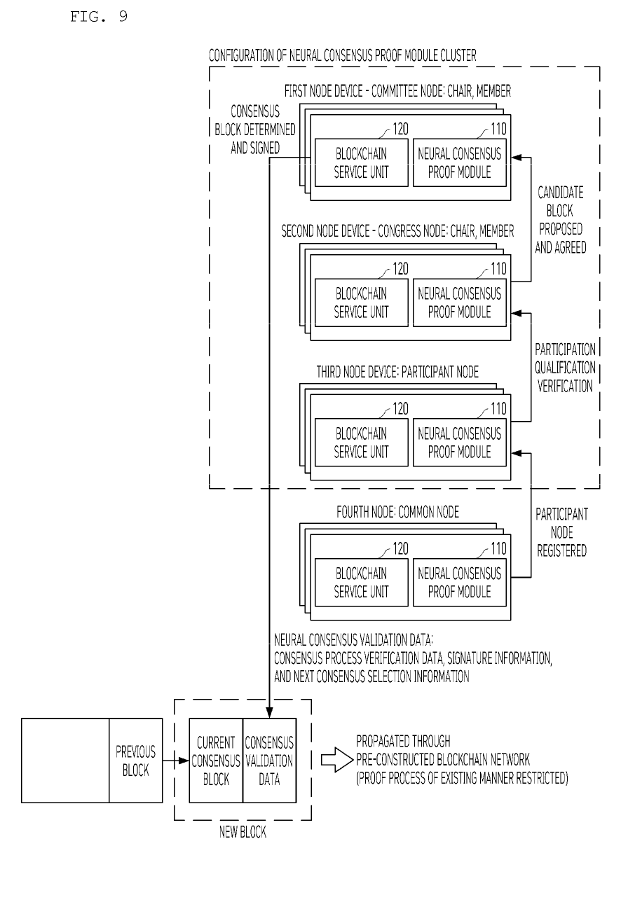

Meanwhile, referring to FIGS. 8 and 9, FIG. 8 is a block diagram showing in more detail a node device according to an embodiment of the present disclosure and FIG. 9 is a conceptual diagram for explaining the configuration of a neural consensus proof module cluster according to an embodiment of the present disclosure and the entire process.

The node devices 100 of the blockchain system 1000 according to the present disclosure may be included in a neural consensus proof module cluster for configuring a next block through a random node selection process and each may include a neural consensus proof module 110 included in the neural consensus proof module cluster to perform a random consensus proof process according to an embodiment of the present disclosure.

Further, the node devices 100 are connected to the non-random consensus blockchain network 200 and each may include a blockchain service unit 120 performing a sharing-propagating process of a next block configured by the random consensus proof process through the non-random consensus blockchain network 200.

Accordingly, in an embodiment of the present disclosure, the node devices 100 may be node devices 100 that participate in the non-random consensus blockchain network 200, and are selected by the random consensus selection process and selectively granted with a right to be able to create respective blocks in accordance with consensus conference, and accordingly, the random consensus blockchain network system 1000 can be independently constructed.

Further, as shown in FIG. 4, the node devices 100 can selectively perform the functions of a fourth node device that is a common node, a third node device that is a participant node, a second node device that is a congress node, and a first node that is a committee node.

The neural consensus proof module cluster may be constructed with the third node device registered as a participant node for a basis. The participant node that is the third node device can verify a participation qualification on the basis of next consensus selection information that is obtained from consensus validation data of a new propagated block and the second node device may be a terminal that processes a congress node function operation by ascertaining whether a congress node is selected in accordance with the verification result. The first node device may be a terminal that processes a committee node function operation by ascertaining whether a committee node is selected in accordance with the verification result.

A node device 100 selected as a congress node can perform a candidate block proposal and consensus process like the second node device shown in FIG. 4, and a node device 100 selected as a committee node can perform a process of configuring and distributing consensus validation data of a next block by determining a consensus block and collecting signature information. In this case, the consensus validation data may include conference process verification data, multiple signature information, and next consensus selection information, and can be propagated through a pre-constructed non-random consensus blockchain network 200.

As a new block is configured and propagated in this way, the proof process of the existing non-random consensus blockchain network 200 can be processed to be restricted and Pow or Pos proof-based next block creation between node devices 100 can be processed only in an exceptional case in which the number of some nodes lacks a number set on the basis of a PBFT standard.

Meanwhile, such a participation qualification and verification information of the nodes 100 can be calculated on the basis of a random value, which is calculated for each node in accordance with participant node registration, and can be mutually opened and verified, in which a nonce chain can be used, as described above. For example, the node devices 100 can be determined as at least one of a participant node, a congress node, a committee node, or a chair node, depending on what value a self qualification verification value accompanying hash processing, which uses a nonce value included in next consensus selection information, a height value of a current block, etc., is.

Further, as shown in FIG. 8, a node device 100 according to an embodiment of the present disclosure includes a device information setting unit 111, a node information setting unit 112, an validation processing unit 113, a qualification verification processing unit 114, a consensus node functioning unit 115, and a data interface unit 116.

The device information setting unit 111 obtains, stores, and manages device information of a terminal 100 in which the neural consensus proof module 110 is installed. In this case, the device information may include at least one of node name information, device address information, device performance information, device reliability information, a used network information of the terminal 100. The device information can be used to recognize or construct a neural consensus proof module cluster, perform a vote consensus process, etc.

The node information setting unit 12 sets node information for registering a non-random consensus blockchain network 200 and a participant node. The set node information may include blockchain network client address information and the terminal 100 can connect to the blockchain network using the blockchain network client address information and can obtain or share block information.

The validation processing unit 113 obtains new block data propagated through the non-random consensus blockchain network 200, extracts validation data from the new block data, and obtains neural consensus designation information of a next block created on the basis a random consensus proof process in accordance with verification processing of the validation data.

Further, the consensus node functioning unit 115 is selectively driven on the basis of the neural consensus designation information of a next block and creates validation data of the next block, and can selectively drive at least one of a chair node functioning unit 1151, a congress node functioning unit 1152, and a committee node functioning unit 1153. The chair node functioning unit 1151 may be selectively operated through at least partial comparison of neural consensus designation information and the nonce value of a designated node device 100, but the present disclosure is not limited to this selection manner.

First, the chair node functioning unit 1151 can perform a chair process corresponding to congress and committee nodes and can collect, from congress nodes, delegation information and participation qualification verification information of an effective transaction block taken from a transaction pool of a blockchain network, and next block consensus candidate information. Accordingly, 3f + 1 (f is a natural number) or more congress nodes for the next block can be selected and 2f+1 or more committee nodes can be selected.

Further, the congress node functioning unit 1152 can transmit delegation information and participation qualification verification information of an effective transaction block taken from a transaction pool of the non-random consensus blockchain network 200 to the node device 100 in which the chair node functioning unit 1151 is driven.

Further, the chair node functioning unit 1151 can select a block coinciding over a consensus quorum of a congress node as a candidate block from transaction blocks proposed by the congress node, can transmit a message requesting partial signature processing for multiple signature regions expressing consensus for the candidate block to node devices 100 in which the committee node functioning unit 1153 was driven. For example, the chair node functioning unit 1151 can determine f+1 coinciding transaction data candidate blocks from 2f+1 transaction data candidate blocks and can transmit a message requesting partial signature processing for multiple signature regions to the committee functioning node 1153, and a node 100 in which the committee node functioning unit 1153 was driven can process and transmit partial signatures expressing consensus corresponding to the candidate blocks to the node device 100 in which the chair node functioning unit 1151 was driven

Accordingly, the chair node functioning unit 1151 verifies and determines a candidate block for which multiple signature processing has been finished in accordance with committee consensus as distribution block, and creates a new block by creating and combining validation data corresponding to the consensus process with the distribution block.

The data interface unit 116 can convert the crated new block into the format of the non-random consensus blockchain network 200 and then transmit the new block to the blockchain service unit 120.

Then, the blockchain service unit 120 can propagate the new block through the non-random consensus blockchain network 200, and the new block not only can be propagated through the non-random consensus blockchain network 200, but can be added to a transaction data memory pool (mem pool) by operation of a transaction data management unit 121.

Meanwhile, though not shown, the node device device 100 may include a memory that the blockchain service unit 120 and the neural consensus proof module 110 can use. The memory may include computer-readable instructions, and as the instructions stored in the memory are executed in a processor, the blockchain service unit 120 and the neural consensus proof module 110 can perform the operations described above. The memory may be a volatile memory or a nonvolatile memory.

The memory may include a storage to store data of a user. The storage may be an embedded multimedia card (eMMC), a solid state drive (SSD), a universal flash storage (UFS), etc. The storage may include at least one or more nonvolatile memory device. The nonvolatile memory device may be a NAND Flash Memory, a Vertical NAND (VNAND), a NOR Flash Memory, a Resistive Random Access Memory (RRAM), a Phase-Change Memory (PRM), a Magnetoresistive Random Access Memory (MRAM), a Ferroelectric Random Access Memory (FRAM), a Spin Transfer Torque Random Access Memory (STT-RAM), etc.

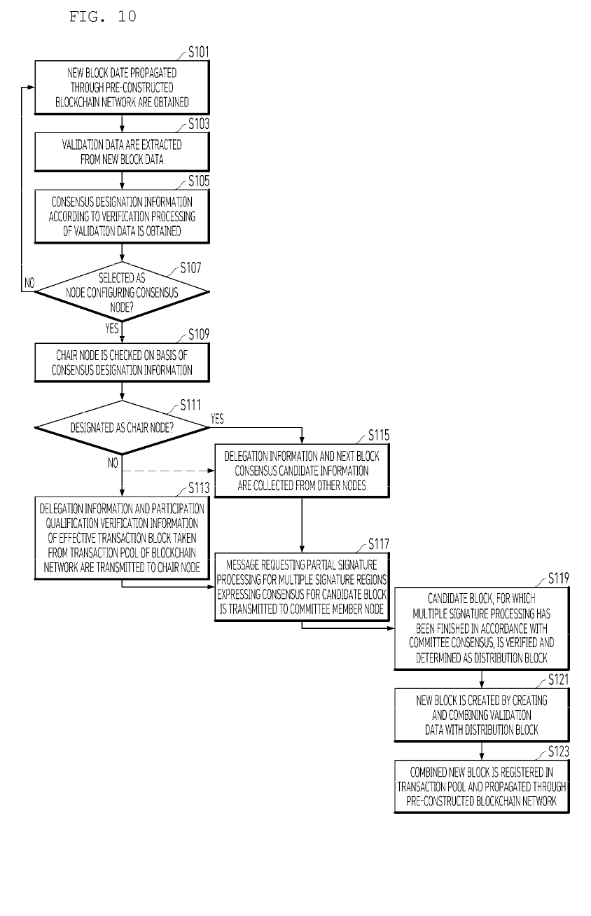

FIG. 10 is a flowchart for explaining a method of operating a node device 100 according to an embodiment of the present disclosure.

Referring to FIG. 10, when a node device 100 according to an embodiment of the present disclosure obtains new block data propagated through a pre-constructed non-random consensus blockchain network 200 (S101), the validation processing unit 113 extracts validation data from the new block data and obtains consensus designation information according to verification processing of the validation data (S103).

The validation processing unit 113 can obtain neural consensus designation information of a next block created on the basis of a random consensus proof process, in accordance with verification processing of the validation data, and as described above, the validation data may include consensus process verification data corresponding to the random consensus proof process.

For example, the consensus process verification data may include nonce chain-based qualification proof hash data and multiple signature data formed by combining partial signatures of the congress node as member qualification verification information of a congress node that processes consensus for transaction data. Further, the neural consensus designation information of a next block may include nonce information for verifying the neural consensus participation qualification corresponding to the next block.

Then, the node device 100 determines whether it has been selected as a node configuring a neural consensus proof cluster node for the next block (S107), and ascertains whether it is a chair node on the basis of consensus designation information when it has been selected (S109).

When the node device has not been selected as a chair node, it can transmit delegation information and participation qualification information of the effective transaction block taken from the transaction pool of the blockchain network in accordance with the qualification to a congress chair node (S113).

Accordingly, a node device 100 in which the chair node functioning unit 1151 was driven can collect delegation information and next block consensus candidate information from other nodes (S115).

Further, the node device 100 in which the chair node functioning unit 1151 was driven determines an agreed candidate block from node devices 110 in which the congress node functioning units 1152 were driven, and transmits a message requesting partial signature processing for multiple signature regions expressing consensus for the candidate block to a committee member node (S117).

Further, the node device 100 in which the chair node functioning unit 1151 was driven verifies and determines a candidate block, for which multiple signature processing has been finished in accordance with the committee consensus, as a distribution block (S119), creates a new block by creating and combining validation data with the distribution block (S121), registers the combined new block into the transaction pool of the non-random consensus blockchain network 200, and propagates the new block through the pre-constructed non-random consensus blockchain network 200 (S123).

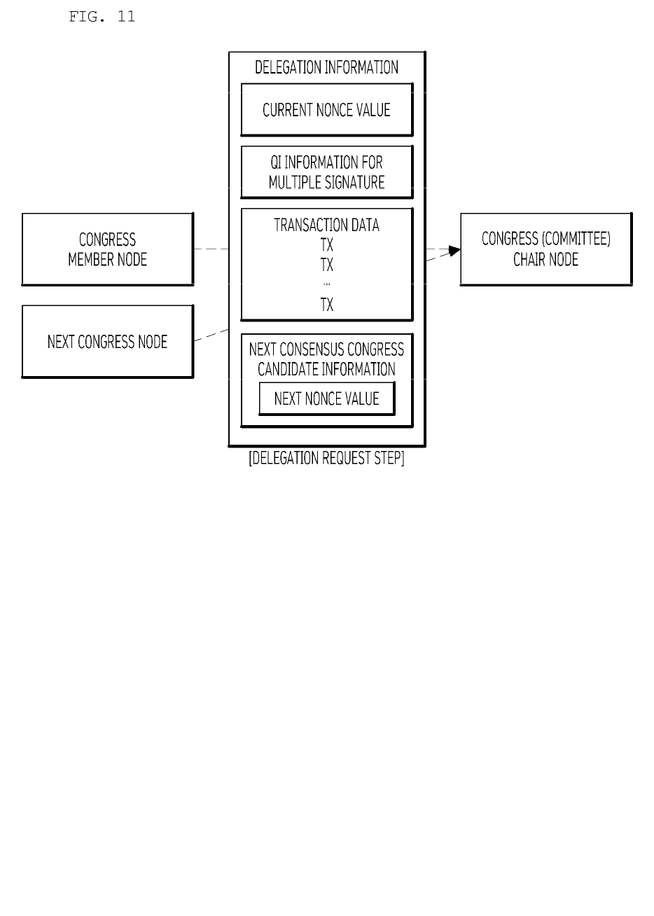

FIGS. 11 to 14 are views exemplifying data of each step that are processed by a consensus proof module node device according to an embodiment of the present disclosure.

FIG. 11 exemplifies delegation information that is transmitted to a chair node in a delegation request step for configuring a current block, in which a nonce value corresponding to a current block height, Qi value information that each congress node intends to use for multiple signatures, transaction data, next consensus congress candidate information, and a nonce value of the next block height may be included in the delegation information.

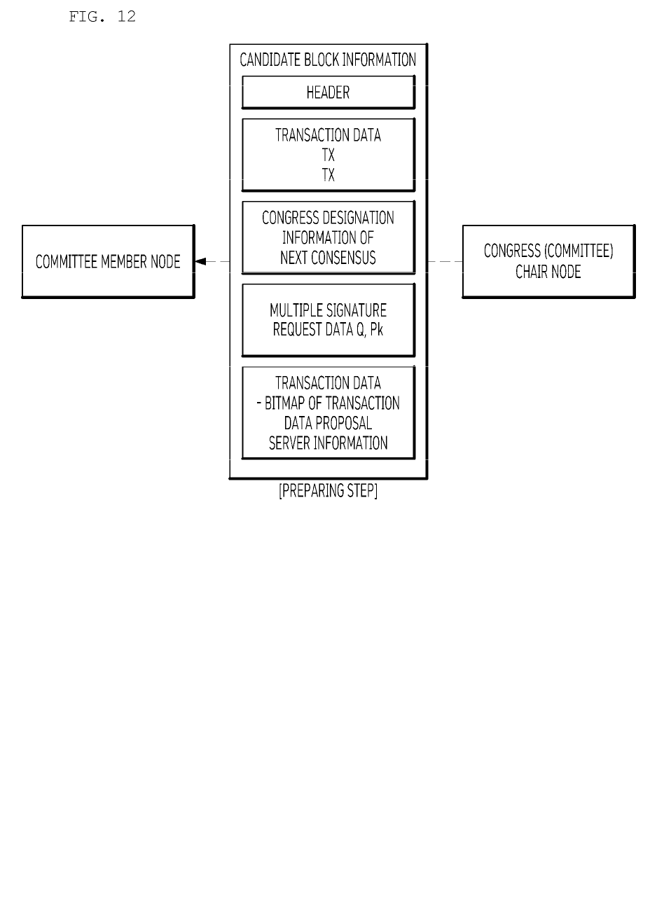

Further, FIG. 12 exemplifies candidate block information that is transmitted to a committee node from a chair node in a preparation step, in which the candidate block information may include header information including a Merkle root, candidate block transaction data, congress designation information of a next consensus, multiple signature request data (Q data integrating Qi, open key Pk), and verification data. Bitmap information that makes it possible to recognize server information proposing transaction data, etc. may be exemplified as the verification data, which makes it possible to prevent a case, etc. proposed by a chair node itself.

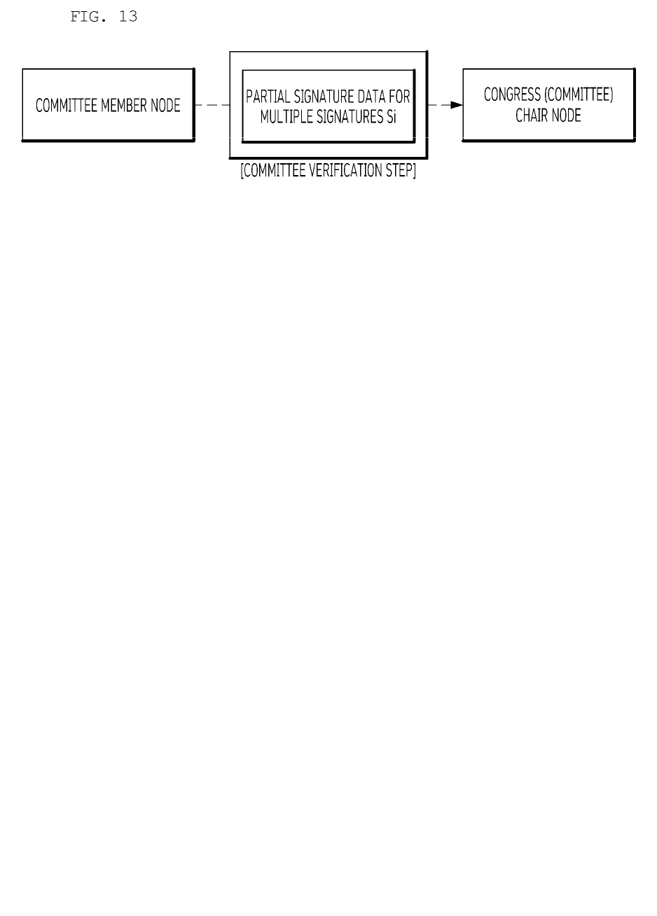

Further, FIG. 13 exemplifies partial signature data that are propagated to a chair node from a committee node in a process in which committee verification is processed, in which the chair node can calculate signature completion data S by integrating partial signature data Si.

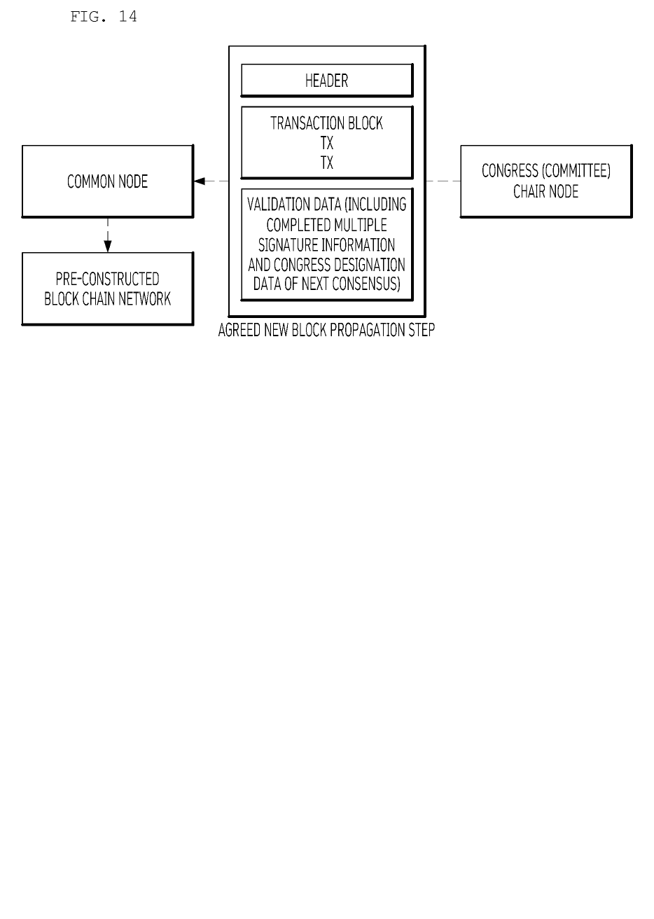

Meanwhile, FIG. 14 shows the configuration of a new block that is created and propagated in accordance with an embodiment of the present disclosure, in which the new block may include header information, transaction block information, and validation data. The validation data, as described above, may include next consensus designation information, completed multiple signature information, and various items of information that can verify a consensus process and a participation qualification. Further, a Merkle root value for validation of block data themselves, etc. may be included also in the header information.

Accordingly, the validation processing unit 113 primarily verifies a consensus process by first ascertaining multiple signature information, can perform secondary verification by ascertaining whether the Merkle root value of a header is normal, and performs third verification by comparing the Merkle root value with a Merkle root value calculated again using transaction block information, thereby enabling safe processing of a transaction block.

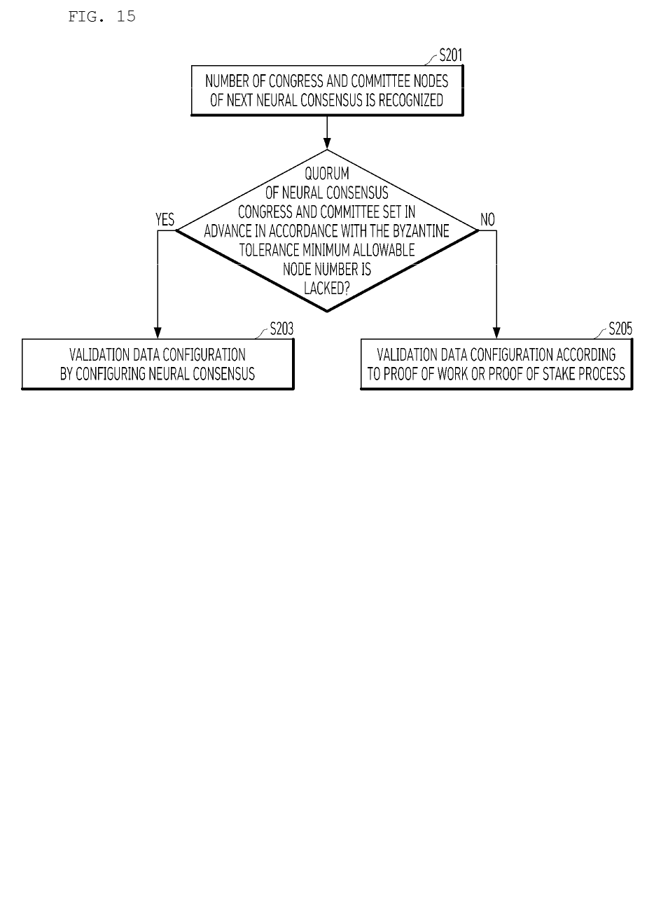

FIG. 15 is a flowchart for explaining a method of operating a node device device according to another embodiment of the present disclosure.

Referring to FIG. 15, a node device 100 according to another embodiment of the present disclosure first recognizes the number of congress and committee nodes of a next neural consensus (S201).

Further, the node device 100 determines whether a preset consensus quorum is not reached on the basis of Byzantine tolerance minimum allowable node number.

For example, a consensus quorum can be determined by a maximum Byzantine number (maximum allowable number of malicious nodes) that can be selected by a node selection probability P in correspondence to the number N of participant nodes, and when congress nodes are at least 3f+1 (f is a natural number) and committee nodes are at least 2f+1 or more, the nodes can satisfy the consensus quorum.

When the number of consensus nodes lacks the quorum of neural consensus congress and committee set in advance in accordance with the Byzantine tolerance minimum allowable node number, the node device 100 performs selective exceptional processing of forming the validation data of a next block in the Proof of Work (PoW) or Proof of stake (Pos) manner (S205).

On the contrary, when the number of consensus nodes is equal to or more than the quorum of neural consensus congress and committee set in advance in accordance with the Byzantine tolerance minimum allowable node number, the Proof of Work (PoW) or Proof of stake (Pos) process of the non-random consensus proof-based blockchain network is restricted, a neural consensus is configured using the process of FIG. 5 described above, and validation data are configured, thereby being able to create and propagate a new block (S203).

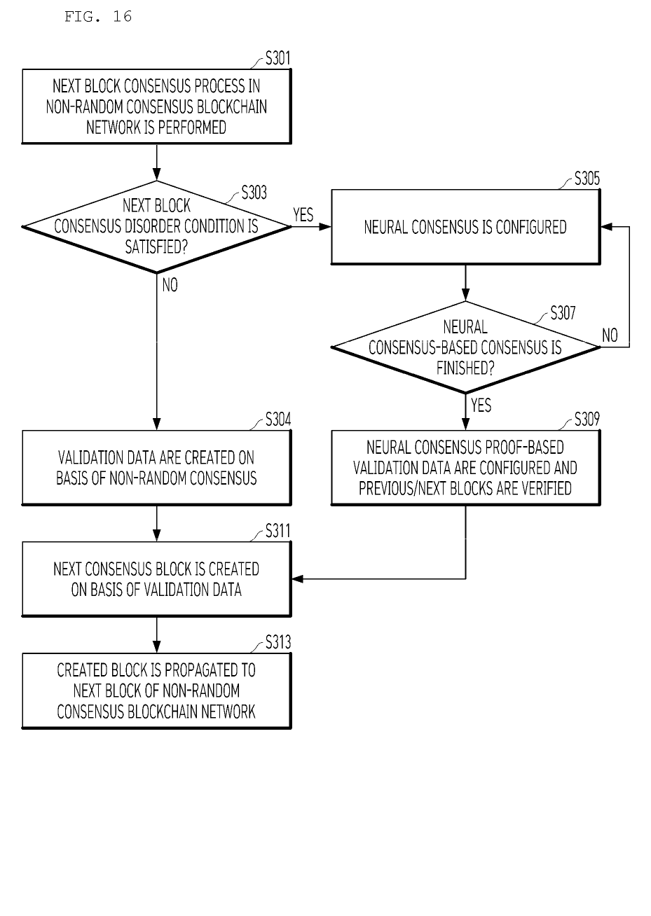

FIG. 16 is a flowchart for explaining a method of operating a node device device according to another embodiment of the present disclosure.

Referring to FIG. 16, performing processes of recognition or construction of a neural consensus proof module cluster and a vote consensus process according to another embodiment of the present disclosure can be used to quickly create a next block to secure continuity when a disorder is generated in a non-random consensus blockchain network 200.

In general, in a non-random consensus manner of proof of work or proof of stake such as Ethereum, there are problems such as timeout of a block creation cycle or unstable consensus by repeated transactions due to abnormal service driving or overload. Accordingly, a service is temporarily stopped or hardfork is performed, so a current non-random consensus blockchain network 200 is not guaranteed with sufficient continuity in block creation and is vulnerable to dealing with disorders.

Accordingly, a process, which performs recognition or construction of a neural consensus proof module cluster and a vote consensus process according to an embodiment of the present disclosure, is complementarily performed when a disorder is generated while the existing non-random consensus blockchain network 200 is driven, so the process can be applied in a manner of securing continuity.

This can be achieved by setting one or more of node devices constituting the existing non-random consensus blockchain network 200 to operate as the node device 100 constituting the neural consensus proof module cluster described above without constructing a specific infrastructure when a preset disorder condition is generated.

In more detail, referring to FIG. 16, the node devices 100 according to an embodiment of the present disclosure may be node devices constituting the non-random consensus blockchain network 200 and may be terminals that operate as node device 100 constituting a neural consensus proof module cluster and configure and propagate neural consensus-based validation data as a next block when a preset next block consensus disorder condition is generated.

For such configuration, the node devices 100 may be driven as devices constituting a preset neural consensus proof module cluster and may be driven in a continuity security mode for securing continuity unlike converting and driving the existing block chain described above.

For example, the node devices 100 can be driven in any one of a network conversion mode in which the node devices 100 convert and use the existing non-random consensus blockchain network 200 as a random consensus blockchain network and a continuity security mode in which the node devices 100 are driven in an assistant manner when a disorder is generated in the existing non-random consensus blockchain network 200, and FIG. 16 shows the operation in the continuity security mode.

First, a node device 100 performs a next block consensus process in a common non-random consensus blockchain network 200 (S301).

Further, the node device 100 determines whether a next block consensus disorder condition is generated (S303).

In this case, various conditions may be set in advance for the next block consensus disorder condition, and preferably, a timeout condition when a block is not created for a first time may be used. For example, the first time may be the same as a second time that is a timeout time prescribed in the process of proof of work or proof of stake of the non-random consensus blockchain network 200.

Further, the first time may be set as a time shorter than the second time in consideration of continuity of work such that configuring a neural consensus proof module cluster is processed earlier than the timeout of the non-random consensus blockchain network 200.

Further, temporal service stop, etc. may be exemplified as the next block consensus disorder condition. For example, when the service of the non-random consensus blockchain network 200 is stopped due to hardfork or temporal service operation problem, assistant block creation processing that accompanies configuring a neural consensus proof module cluster may be set to be continuously performed.

When a disorder condition about the next block consensus is not generated, non-random consensus-based validation data on the non-random consensus blockchain network 200 are created in the manner of common proof of work or proof of stake (S304).

Further, when a disorder condition about the next block consensus is generated, the node device 100 described above can operates as the node device 100 constituting a neural consensus proof module cluster and performs the random-type neural consensus proof module cluster configuration process described with reference to FIGS. 4 and 5 and a consensus process based on the process (S305).

When consensus based on the neural consensus proof module cluster is finished (S307), the node device 100 configures neural consensus proof-based validation data and verifies data effectiveness between a previous block and a next block configured in the non-random consensus blockchain network 200 on the basis of the configured validation data (S309).

In this case, specific height information, previous block information, and next block information can be used for data validation between the previous block and the next block, and a block of non-random consensus format that can be used in the non-random consensus blockchain network 200 can be used through validation on the basis of the information.

Thereafter, the node device 100 creates a next consensus block based on the non-random consensus-based validation data in step S304 or the neural consensus proof-based validation data verified in step S309 (S311).

For example, the node device 100 creates a next block including the neural consensus proof-based validation data, that is, can create a next block of non-random consensus format verified by step S309. In more detail, when a current maximum height is 100, the node device 100 can create a next block that makes consensus be restarted on the non-random consensus blockchain network 200 from a block having a height of 110.

Further, the node device 100 propagates the created block as the next block of the non-random consensus blockchain network 200 (S313).

As such process of the node device 100 is performed, a neural consensus proof-based block creation process, which is driven in an assistant manner when a disorder is generated in the non-random consensus blockchain network 200 of proof of work or proof of stake manner such a Ethereum or Bitcoin, is performed, so continuity of a service can be sufficiently secured.

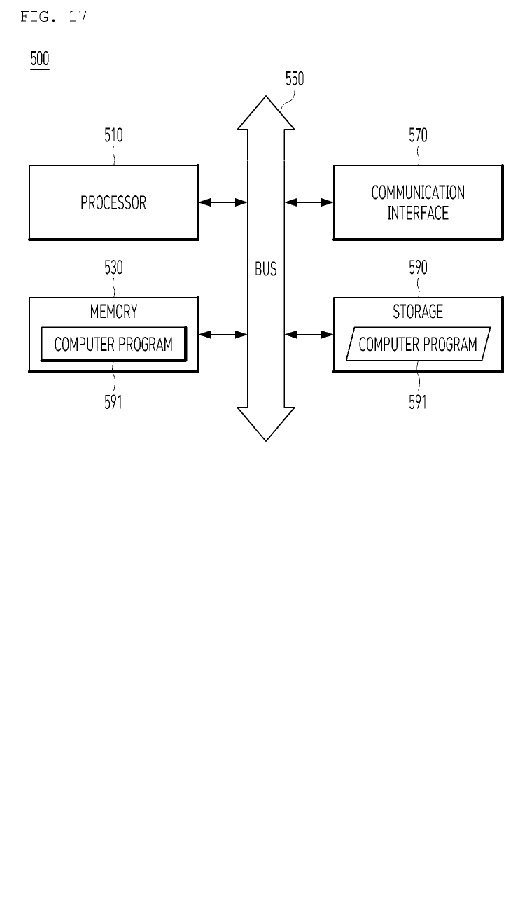

Hereinafter, an exemplary computing device 500 in which methods described in various embodiments of the present disclosure are implemented will be described with reference to FIG. 17. For example, the computing device 500 of FIG. 17 may be the node device 100 or the platform service provision apparatus 300 of FIG. 2.

FIG. 17 is an exemplary hardware configuration diagram illustrating the computing device 500.

As shown in FIG. 17, the computing device 500 may include one or more processors 510, a bus 550, a communication interface 570, a memory 530 for loading a computer program 591 executed by a processor 510, a storage 590 for storing computer programs 591. However, only components related to the embodiment of the present disclosure are shown in FIG. 17. Accordingly, those skilled in the art will appreciate that other general-purpose components other than those shown in FIG. 17 may be further included.

The processor 510 controls the overall operation of each component of the computing device 500. The processor 510 may be configured to include a central processing unit (CPU), micro-processor unit (MPU), micro-controller unit (MCU), and graphic processing unit (GPU), or at least one of any type of processor well known in the art. Additionally, the processor 510 may perform operations on at least one application or program to execute methods/operations according to various embodiments of the present disclosure. The computing device 500 may include one or more processors.

The memory 530 stores various data, commands and/or information. The memory 530 may load one or more programs 591 from the storage 590 to execute methods/operations according to various embodiments of the present disclosure. An example of the memory 530 may be RAM, but is not limited thereto.

The bus 550 provides communication functionality between components of computing device 500. The bus 550 may be implemented as various types of buses, such as an address bus, a data bus, and a control bus.

The communication interface 570 supports wired and wireless Internet communication of the computing device 500. The communication interface 570 may support various communication methods other than Internet communication. To this end, the communication interface 570 may be configured to include a communication module well known in the technical field of the present disclosure.

The storage 590 may store one or more computer programs 591 as non-transitory media. The storage 590 may be configured to include command memory such as read only memory (ROM), erasable programmable ROM (EPROM), electrically erasable programmable ROM (EEPROM), flash memory, a hard disk, a removable disk, or any form of computer-readable recording medium well known in the art to which the present disclosure pertains.

The computer program 591 may include one or more instructions to allow methods/operations according to various embodiments of the present disclosure to be implemented.

For example, the computer program 591 may comprises instructions for performing operations comprising: an operation for registering resume ledger data corresponding to a first user on a ledger information database organized on the basis of user information, an operation for performing verification processing on at least one of educational history information, career information, and portfolio information, which are obtained on the basis of the resume ledger data, an operation for combining verification information generated according to the verification processing and the educational history information, career information, and portfolio information, so as to organize history block data, propagate the history block data to a neural consensus proof-based blockchain network, and establish a connection to a new block shared through the blockchain network, and an operation for registering the history block data propagated to the blockchain network in the ledger information database by mapping the history block data to the resume ledger data.

When the computer program 591 is loaded into the memory 530, the processor 510 may perform methods/operations according to various embodiments of the present disclosure by executing the one or more instructions.

The technical idea of the present disclosure described above may be implemented as computer-readable code on a computer-readable medium. The computer-readable recording medium may be, for example, a removable recording medium (CD, DVD, Blu-ray disk, USB storage device, removable hard disk), or a fixed recording medium (ROM, RAM, computer-equipped hard disk). The computer program recorded on the computer-readable recording medium may be transmitted to another computing device through a network such as the Internet and installed on the other computing device, thereby allowing it to be used in other computing devices.

Although embodiments of the present disclosure have been described above with reference to the attached drawings, those skilled in the art can appreciate that the present disclosure can be implemented in other specific forms without changing its technical idea or essential features. Therefore, the embodiments described above should be understood in all respects as illustrative and not restrictive. The scope of protection of the present disclosure should be interpreted in accordance with the claims below, and all technical ideas within the equivalent scope should be construed as being included in the scope of the technical ideas defined by the present disclosure.

What is claimed is:

1. A method of operating a service provision apparatus, the method comprising:
registering resume ledger data corresponding to a first user on a ledger information database organized on the basis of user information;
performing verification processing on at least one of educational history information, career information, and portfolio information, which are obtained on the basis of the resume ledger data;
combining verification information generated according to the verification processing and the educational history information, career information, and portfolio information, so as to organize history block data, propagate the history block data to a neural consensus proof-based blockchain network, and establish a connection to a new block shared through the blockchain network; and
registering the history block data propagated to the blockchain network in the ledger information database by mapping the history block data to the resume ledger data.

2. The method of claim 1, wherein the neural consensus proof-based blockchain network comprises a non-random consensus proof-based blockchain network and a node device constituting a neural consensus proof module cluster,
the node device obtains new block data propagated through the non-random consensus proof-based blockchain network and performs a neural consensus proof-based block generation process corresponding to the new block data according to preset conditions,
the neural consensus proof-based block generation process comprises:
extracting validation data from the new block data;
obtaining neural consensus designation information of a next block, which is generated on the basis of a random consensus proof process, according to the verification processing of the validation data; and
generating validation data of the next block by selectively operating a consensus node function unit on the basis of the neural consensus designation information of the next block, and
wherein the validation data of the next block comprises consensus process verification data corresponding to the random consensus proof process.

3. The method of claim 2, wherein the consensus process verification data comprises multi-signature data formed by combining member verification information of a congress node, which processes consensus on transaction data, and partial signatures of the congress node,
wherein the neural consensus designation information of the next block comprises nonce information for verifying neural consensus participation qualification corresponding to the next block, and
wherein the non-random consensus proof-based blockchain network is a blockchain network using a Proof of Work (PoW) or a Proof of stake (PoS) method.

4. The method of claim 1, wherein the performing of the verification processing comprises:
receiving first educational history information corresponding to the first user from an education platform service device connected through the neural consensus proof-based blockchain network;
requesting internal platform verification corresponding to the first educational history information to one or more first personal relationship terminals connected through the neural consensus proof-based blockchain network; and
generating first verification information corresponding to the first educational history information by using response information from each first personal relationship terminal.

5. The method of claim 4, wherein the performing of the verification processing comprises:
receiving external history information or external career information corresponding to the first user from a user terminal separated from the neural consensus proof-based blockchain network;
requesting verification of the external history information or external career information from one or more second personal relationship terminals corresponding to the external history information or external career information; and
generating second verification information corresponding to the external history information or external career information by using response information from each second personal relationship terminal.

6. The method claim 1, further comprising:
performing a company matching service process using the resume ledger data to which the history block data is mapped according to the performing of the history information platform service.

7. The method of claim 6, wherein the performing of the company matching service process comprises:
identifying first resume ledger data matched with company information based on the history block data normally formed, and providing the first resume ledger data to one or more company terminals.

8. The method of claim 7, wherein the performing of the company matching service process further comprises:
providing compensation information to the personal relationship terminals used to generate verification information of the history block data mapped with the first resume ledger data on the basis of the first resume ledger data that is provided to the company terminals.

9. The method of claim 6, wherein the performing of the company matching service process comprises:
obtaining company information from company terminals;
organizing competency set information on the basis of the company information;
organizing education course data comprising project information and the portfolio information on the basis of the competency set information;
organizing first education course information and first portfolio information corresponding to the first user by comparing the education course data with the history block data of the first user;
providing a first education service process to a user terminal of the first user by using the first education course information and the first portfolio information;
organizing education completion verification information as completion of providing the first education service process is confirmed and using the first portfolio information and the education completion verification information to update the history block data of the first user; and
organizing prospective employee recommendation information using the resume ledger data corresponding to the updated history block data to provide the prospective employee recommendation information to the company terminal.

10. A service provision apparatus comprising:
a ledger information registration unit for registering resume ledger data corresponding to a first user on a ledger information database organized on the basis of user information;
a history verification management unit for performing verification processing on at least one of educational history information, career information, and portfolio information, which are obtained in response to the resume ledger data;
a blockchain processing unit for combining verification information generated according to the verification processing and the educational history information, career information, and portfolio information, so as to organize history block data, propagate the history block data to a neural consensus proof-based blockchain network, and establish a connection to a new block shared through the blockchain network; and
a service provision unit for registering the history block data propagated to the blockchain network in the ledger information database by mapping the history block data to the resume ledger data.

11. The service provision apparatus of claim 10, wherein the neural consensus proof-based blockchain network comprises a non-random consensus proof-based blockchain network and a node device constituting a neural consensus proof module cluster,
the node device obtains new block data propagated through the non-random consensus proof-based blockchain network and performs a neural consensus proof-based block generation process corresponding to the new block data according to preset conditions,
the neural consensus proof-based block generation process comprises:
extracting validation data from the new block data;
obtaining neural consensus designation information of a next block, which is generated on the basis of a random consensus proof process, according to the verification processing of the validation data; and
generating validation data of the next block by selectively operating a consensus node function unit on the basis of the neural consensus designation information of the next block, and
wherein the validation data comprises consensus process verification data corresponding to the random consensus proof process.

12. The service provision apparatus of claim 10, wherein the service provision unit performs a company matching service process using the resume ledger data to which the history block data is mapped according to the performing of the history information platform service.

13. A computing apparatus comprising:
a processor;
a memory for loading a computer program executed by the processor; and
a storage for storing the computer program,
wherein the computer program comprises instructions for performing operations comprising:
an operation for registering resume ledger data corresponding to a first user on a ledger information database organized on the basis of user information;
an operation for performing verification processing on at least one of educational history information, career information, and portfolio information, which are obtained on the basis of the resume ledger data;
an operation for combining verification information generated according to the verification processing and the educational history information, career information, and portfolio information, so as to organize history block data, propagate the history block data to a neural consensus proof-based blockchain network, and establish a connection to a new block shared through the blockchain network; and
an operation for registering the history block data propagated to the blockchain network in the ledger information database by mapping the history block data to the resume ledger data.
